(19) United States
(12) Patent Application Publication
(10) Pub. No.: US 2010/0171749 A1
(43) Pub. Date: Jul. 8, 2010

(54) DRIVING APPARATUS OF DISPLAY AND OVER DRIVING METHOD THEREOF

(75) Inventors: Min-Jung Chen, Changhua County (TW); Jen-Ta Yang, Hsinchu County (TW); An-Hsu Lee, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 12/428,476

(22) Filed: Apr. 23, 2009

(30) Foreign Application Priority Data
Jan. 6, 2009 (TW) 98100168

(51) Int. Cl. G09G 5/36; G06F 3/038

(52) U.S. Cl. 345/547; 345/212

(57) ABSTRACT

An over driving method for a display is disclosed. The steps of the method mentioned above includes the following. A power saving parameter is set equal to an initial value, a current frame data is received, and a previous frame data is read from a memory. Afterward, the power saving parameter is updated by comparing the current frame data and the previous frame data. Moreover, an over driving process is executed to the display according to the comparison result for the power saving parameter and a reference value.

### CROSS-REFERENCE TO RELATED APPLICATION

This application claims the priority benefit of Taiwan application serial no. 98100168, filed Jan. 6, 2009. The entirety of the above-mentioned patent application is hereby incorporated by reference herein and made a part of specification.

### BACKGROUND OF THE INVENTION

1. Field of the Invention

The present invention relates to a driving apparatus and a driving method thereof More particularly, the present invention relates to an over driving method of a driving apparatus of a display.

2. Description of Related Art

With the advance of electronic technology, the demands of consumers for electronic products with the multimedia playing function also increase gradually. Especially in the part of playing images, the conventional displays not only provide the function of playing static frames, but the requirement for playing dynamic frames has also become a basic functional demand.

In the displays with larger sizes, in order to improve the performance in playing images, a driving method of over driving (OD) has been proposed. Here, in the liquid crystal display (LCD) panel, as the turnover speed of liquid crystals is much slower compare to the response speed of the driving voltage, the over driving method utilizes a greater driving voltage to increase the turnover rate of the liquid crystals so as to increase the grayscale performance of the display.

Referring to FIG. 1, FIG. 1 shows a flow chart of a conventional over driving method. In the conventional over driving method, firstly, a current frame data is received (S110). Next, a previous frame data stored in a memory is read (S120). Thereafter, the current frame data and the previous frame data are compared to produce a new frame data (S130). The new frame data is used to generate a corresponding driving voltage to drive a display (S150). To give an example, if the grayscale value of the previous frame data is 0, and the grayscale value of the current frame data is 63, in order for liquid crystals to rapidly turnover to the position with the grayscale value of 63, the grayscale value of 80 is applied as the new frame data to over drive the display. Moreover, the current frame data is stored in the memory (S140) and used as the previous frame data to be compared to when displaying a next frame.

As above mentioned, the conventional over driving method has to access the memory regardless of the frame data received is the static frame or the dynamic frame. Nevertheless, the data in the previous and the current frame data of the static frame are usually similar and do not require repetitive comparison and memory access. The repetitive memory access and comparison are obviously wasting the bandwidth of the memory so as to cause unnecessary power consumption.

### SUMMARY OF THE INVENTION

An over driving method of a display is provided in the present invention to determine whether a display frame is a static frame or a dynamic frame and execute a over driving process correspondingly.

A driving apparatus of a display is provided in the present invention to determine whether a display frame is a static frame or a dynamic frame and execute a over driving process correspondingly.

The over driving method of the display is provided in the present invention. The method includes the following steps. Firstly, a power saving parameter is set equal to an initial value, a current frame data is received, and a previous frame data stored in a memory is read. Next, the power saving parameter is updated by comparing the current frame data and the previous frame data. Finally, the over driving process is executed to the display according to a comparison result of the power saving parameter and a reference value.

The present invention provides the driving apparatus of the display, and the driving apparatus includes the memory and a controller. The memory is used to store the previous frame data. On the other hand, the controller is coupled to the memory to receive the current frame data, read the previous frame data, and compare the current frame data with the previous frame data to update the power saving parameter. Moreover, the controller executes the over driving process corresponding to the display according to the comparison result of the power saving parameter and the reference value.

In light of the foregoing, the present invention can effectively determine whether the frame data displayed is the dynamic frame or the static frame, and correspondingly execute the over driving process. Consequently, the memory used to store the current frame data can avoid repetitive access and is prevented from excessive power consumption. Furthermore, when the static frame is displayed, unnecessary over driving process will not be executed, such that the power consumption can also be saved effectively.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart showing a conventional over driving method.

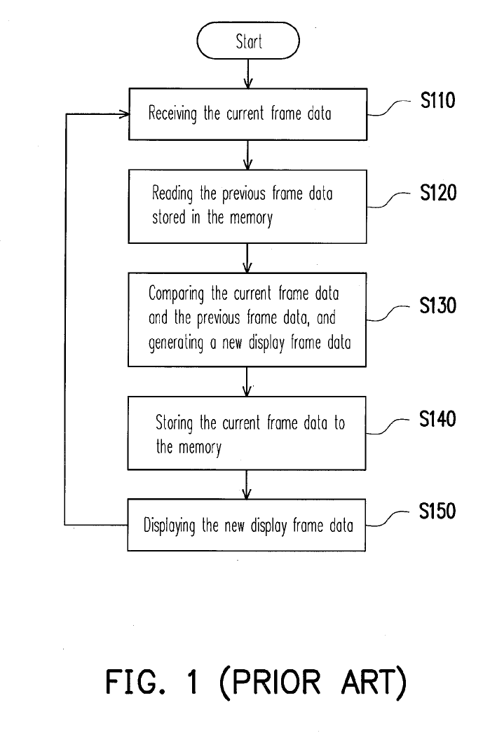

FIG. 2 is a schematic diagram of a driving apparatus 210 of a display according to an embodiment of the present invention.

FIG. 3 is a flow chart showing an over driving method according to an embodiment of the present invention.

### DESCRIPTION OF EMBODIMENTS

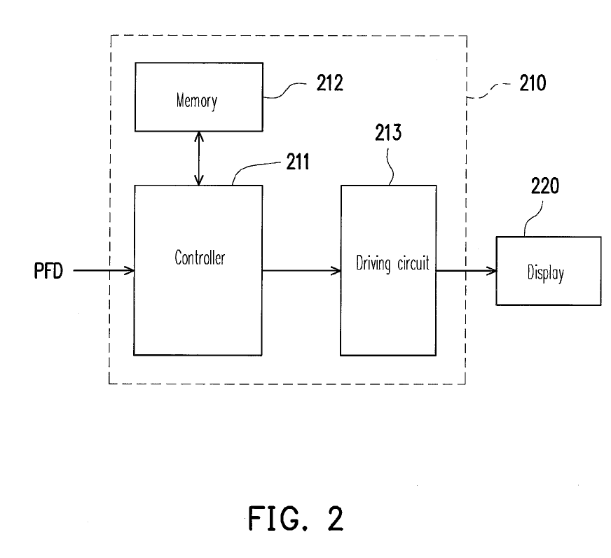

Referring to FIG. 2, FIG. 2 is a schematic diagram of a driving apparatus 210 of a display according to an embodiment of the present invention. The driving apparatus 210 includes a controller 211, a memory 212, and a driving circuit 213. Here, the controller 211 is coupled to the memory 212 and the driving circuit 213. The driving apparatus 210 is also coupled to a driving display 220 to drive the display 220. In the present embodiment, the display 220 is a liquid crystal display (LCD).

In the details of an operation of the driving apparatus 210, the controller 211 receives a current frame data PFD from the exterior, where the current frame data PFD is the frame data to be displayed currently. After the controller 211 receives the current frame data PFD, the controller 211 then reads the previous frame data stored in the memory 212. Moreover, the controller 211 compares the previous frame data read from the memory 212 with the current frame data PFD. This comparison, in brief, is to compare a difference in grayscale values between the two frame data.

Here, if the grayscale difference between the two frame data is small, then the images displayed by the two frame data are almost the same, such that the display 220 is displaying a static frame. In other words, if the grayscale difference between the two frame data is greater than a certain level, then a great difference exists between the images displayed by the two frame data, such that the display 220 is displaying a dynamic image. The aforementioned “difference greater than the certain level” is a comparison critical value provided by a user or a designer. In other words, when the grayscale difference between the current frame data PFD and the previous frame data is greater than the comparison critical value, the image to be displayed by the display 220 can be the dynamic image.

As the frame data may be affected by the interference generated by environmental factors, the difference between the current frame data PFD and the previous frame data may not be accurate. Once the variable of inaccuracy becomes large, such that the difference between the grayscale values of the two frame data is greater than the comparison critical value, the controller 211 will misjudge the image data of the current frame data PFD to be the dynamic image data and perform an inaccurate operation. On the other hand, in the continuous image frame data, when only few of the current frame data have greater differences in their grayscale values while most of the frame data have small differences in their grayscale values, the continuous image frame will not be the dynamic image data. Thus, a power saving parameter is further disposed in the present embodiment. Firstly, the controller 211 set the power saving parameter to an initial value. Once the controller 211 determines the difference between the current frame data PFD and the previous frame data to be greater than the comparison critical value, the controller 211 gradually decrease the power saving parameter (such as deducting the power saving parameter by 1). If the controller 211 determines that the difference between the current frame data PFD and the previous frame data is not greater than the comparison critical value, then the controller 211 gradually increase the power saving parameter (such as increasing the power saving parameter by 1).

Obviously, in order to prevent the power saving parameter from a phenomenon of overflow or underflow, when the controller 211 gradually increases the power saving parameter to a certain upper limit, the power saving parameter not be increased further. On the contrary, when the controller 211 gradually decreases the power saving parameter to a lower limit, the power saving parameter not be decreased further. Moreover, the controller 211 determines whether or not the over driving process is to be executed according to the comparison result of the power saving parameter and the reference value. In other words, when the difference between the current frame data and the previous frame data, which has been compared by the controller 211 repetitively, is greater than the comparison critical value, such that the power saving parameter is decreased gradually to be smaller or equal to the reference value, then the grayscale values of many continuous frame data have been determined to contain great variability. Hence, the display 220 be displaying the dynamic image data, and has to execute the over driving process.

In the execution of the over driving process, the controller 211 stores the current frame data PFD in the memory 212, and over drives the display 220 according to the current frame data PFD and the difference between the current frame data PFD and the previous frame data. To give an example, if the difference between the current frame data PFD and the previous frame data is 10, then the grayscale value of the frame data used to drive the display 220 can be calculated by adding 15 to the current frame data PFD.

It should be noted that the memory 212 applied in the present embodiment is a dynamic random access memory. Obviously, other memories that can be read/written may also be used to practice the present embodiment. This is apparent to one of the ordinary skills in the art, and thus is not repeated herein.

In addition, if the current frame data PFD received by the controller 211 is a first input of the frame data, the controller 211 then stores the current frame data PFD directly to the memory 212, and over drives the display 220 directly according to the current frame data PFD.

Furthermore, a driving circuit 213 receives the frame data generated by the controller 211 and generates a driving voltage correspondingly to drive the display 220. The driving circuit 213 includes a gate driver and a source driver. The driving circuit 213 is a conventional circuit that can be easily applied by anyone skilled in the art, and thus is not repeated herein.

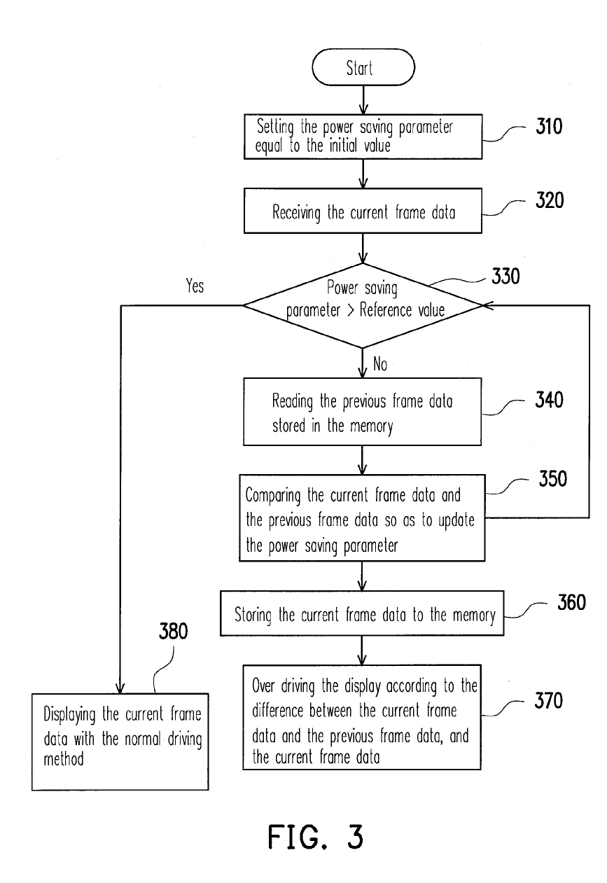

Referring to FIG. 3, FIG. 3 is a flow chart showing an over driving method according to an embodiment of the present invention. The steps include: firstly, setting the power saving parameter equal to an initial value (S310), receiving the current frame data (S320), and determining whether the power saving parameter is greater than the reference value (S330). If the determination result is Yes, then the normal driving method is used to display the current frame data (S390). That is, the grayscale value of the current frame data is used to drive the display directly. If the determination result is No, then the previous frame data stored in the memory is accessed (S340). Also, the previous frame data and the current frame data are compared such that the comparison result is used to update the power saving parameter (S350).

Next, the current frame data is stored to the memory (S360), and the display is driven with a new frame data, which is calculated according to the current frame data and the difference between the current frame data and the previous frame data (S370).

In summary, in the present invention, the access of the dynamic memory is determined by verifying the image to be displayed by the display is the dynamic image or the static image. Hence, the bandwidth use of the memory can be more efficient. Also, the unnecessary power consumption resulting from over access of the memory can be prevented. Moreover, the present invention can also display the static frame without performing the over driving continuously, so that the power can be saved.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An over driving method of a display, comprising:
setting a power saving parameter equal to an initial value;
receiving a current frame data;
reading a previous frame data stored in a memory;
updating the power saving parameter by comparing the current frame data and the previous frame data; and
executing an over driving process to the display according to a comparison result of the power saving parameter and a reference value.

2. The over driving method as claimed in claim 1, wherein the over driving process comprises:
storing the current frame data in the memory; and
over driving the display according to the current frame data and a difference value between the current frame data and the previous frame data.

3. The over driving method as claimed in claim 1, wherein the “updating the power saving parameter by comparing the current frame data and the previous frame data” comprises:
decreasing the power saving parameter gradually when the difference between the current frame data and the previous frame data is greater than a comparison critical value; and
increasing the power saving parameter gradually when the difference between the current frame data and the previous frame data is not greater than the comparison critical value.

4. The over driving method as claimed in claim 3, wherein the “executing the over driving process to the display according to the comparison result of the power saving parameter and the reference value” comprises:
executing the over driving process when the power saving parameter is not greater than the reference value.

5. The over driving method as claimed in claim 1, further comprising:
storing a first input of the current frame data into the memory when the first input of the current frame data is received, and over driving the display according to the first input of the current frame data.

6. The over driving method as claimed in claim 1, wherein the memory is a dynamic random access memory.

7. A driving apparatus of a display, comprising:
a memory, used to store a previous frame data; and
a controller, coupled to the memory to receive a current frame data and read the previous frame data, and updating a power saving parameter by comparing the current frame data and the previous frame data, wherein the controller further executes an over driving process corresponding to the display according to a comparison result of the power saving parameter and a reference value.

8. The driving apparatus of the display as claimed in claim 7, wherein the controller stores the current frame data in the memory, and executes the over driving process by over driving the display according to a difference value between the current frame data and the previous frame data.

9. The driving apparatus of the display as claimed in claim 7, wherein when the controller determines the difference between the current frame data and the previous frame data is greater than a comparison critical value, the controller gradually decreases the power saving parameter, and when the controller determines the difference between the current frame data and the previous frame data is not greater than the comparison critical value, the controller gradually increases the power saving parameter.

10. The driving apparatus of the display as claimed in claim 7, wherein when the controller determines that the power saving parameter is not greater than the reference value, the controller executes the over driving process.

11. The driving apparatus of the display as claimed in claim 7, wherein when the controller receives a first input of the current frame data, the controller stores the first input of the current frame data into the memory, and over drives the display according to the first input of the current frame data.

12. The driving apparatus of the display as claimed in claim 7, wherein the memory is a dynamic random access memory.
